(19) United States
(12) Patent Application Publication
(10) Pub. No.: US 2009/0297690 A1
(43) Pub. Date: Dec. 3, 2009

(54) Production of Sustained Release Starch Product

(76) Inventors: Warren L. Nehmer, Decatur, IL (US); David A. Durkee, Mount Zion, IL (US); Annette Evans, Decatur, IL (US); Shondra Cook, Monticello, IL (US); Doris Dougherty, Decatur, IL (US); Michelle Schwenk, Decatur, IL (US)

Correspondence Address: WILLIAMS, MORGAN & AMERSON, P.C., 10333 RICHMOND, SUITE 1100, HOUSTON, TX, 77042, US

(21) Appl. No.: 12/477,185

(22) Filed: Jun. 3, 2009

Related U.S. Application Data
(60) Provisional application No. 61/058,278, filed on Jun. 3, 2008.

(51) Int. Cl. A23L 1/0522; A23P 1/02

(52) U.S. Cl. 426/661; 426/285

(57) ABSTRACT

A process for producing a sustained release starch product comprises (1) combining and mixing starch, hydrocolloid, and water to form a starch material, and (2) drying the starch material to form a starch product. The dried starch product optionally can be milled to the desired particle size.

This application claims priority from U.S. provisional patent application Ser. No. 61/058,278, filed on Jun. 3, 2008, which is incorporated herein by reference.

### BACKGROUND OF THE INVENTION

Carbohydrates can be classified as being rapidly digestible, slowly digestible, or not digestible (fiber). Rapidly digestible carbohydrates lead to fast release and absorption of glucose into the bloodstream. Examples of rapidly digestible carbohydrates include sucrose, maltodextrins, and cooked starches. Fibers are not digested in the human small intestine and include carbohydrates such as corn bran, oat fiber, gums, and resistant starch. Different types of starch are digested at different rates in the human digestive system.

### SUMMARY OF THE INVENTION

One embodiment of the invention is a process for producing a sustained release starch product. “Sustained release” means that after the starch product is ingested by a human, the starch product supplies glucose to the blood stream such that the blood glucose level is maintained above baseline value for at least 120 minutes after ingestion. The process comprises (1) combining and mixing starch, hydrocolloid, and water to form a starch material, and (2) drying the starch material to form a starch product. The dried starch product optionally can be milled to the desired particle size.

In some embodiments of the process, the starch material can comprise about 80-99.9% by weight starch and about 0.1-20% by weight hydrocolloid on a dry solids basis. The starch material in some embodiments can comprise about 0.1-50% by weight water.

The process can be performed in various ways. For example, in one embodiment, the starch and hydrocolloid are first combined and then water is added. In another embodiment, hydrocolloid is added to an aqueous starch slurry. The combining and mixing can be done simultaneously or sequentially. The mixing can be done, for example, by at least one of agglomeration, extrusion, or roll compaction.

In one embodiment of the invention, the starch, hydrocolloid, and water are combined and mixed by (1) forming an aqueous starch slurry; (2) pumping the slurry through a spray cooking nozzle, where steam is formed and cooks the starch at least partially, resulting in a spray of cooked starch particulates from the nozzle; and (3) contacting the spray of cooked starch particulates with hydrocolloid particulates.

A variety of starches and hydrocolloids can be used. In some embodiments, the starch is native maize or waxy maize starch, and the hydrocolloid is xanthan gum, guar gum, locust bean gum, pullulan, or a combination of two or more thereof.

Another embodiment of the invention is a sustained release starch product that is produced by the above-described process. Yet another embodiment of the invention is a food product comprising the sustained release starch product.

Another embodiment of the invention is a sustained release starch product that has an initial digestion rate<1, a rate constant (k) in the range of 0.1 to 0.4, and shows continued digestion over a 3 hour period, in the in vitro assay described in Example 3 below.

### DESCRIPTION OF SPECIFIC EMBODIMENTS

It has been found that processing native starch with hydrocolloid materials can lead to a desirable starch product that is suitable for use in food, by inhibiting enzyme attack. It has also been found that hydrocolloid processing is less likely to lead to starch which is not digested at all in the small intestine than crystalline melt processing.

A variety of starches can be used, such as maize, tapioca, wheat, or potato starch. The term “starch” is defined herein to include flour, as well as blends of different types of starch or flour. In one embodiment, uncooked starches are used. Alternatively, starches that are partially or completely cooked out, as well as starches that have been retrograded after being partially or completely cooked, can also be used. The degree to which the starch is cooked can be controlled by adjusting the time and temperature of cooking, or by the selection of starch and hydrocolloid (hydrocolloids that hold more water will tend to hinder cooking of the starch) or the ratio of hydrocolloid to starch (a higher ratio will tend to hinder cooking of the starch).

In one embodiment, native dried maize starch (waxy or dent) is mixed with a hydrocolloid (0.1 to 20% dry solids) or a blend of two or more hydrocolloids. The mixture is then hydrated (0.1 to 50% moisture) with agitation to blend the water and dry ingredients. The mixture is then agglomerated, extruded through a dye, or roll compacted to induce microscale mixing of the starch and hydrocolloid and physisorption of the hydrocolloid to the starch. The wet product is dried and then optionally milled to give the desired particle size to the dry starch product.

The methods that can be used in the process include, for example, re-wet agglomeration, vertical granulation/extrusion, and Chilsonation. Each of these methods could have many different modes of operation.

The hydrocolloid optionally can be pre-agglomerated.

In one embodiment, the starch product can be produced via spray cook agglomeration. In this embodiment, a slurry of waxy starch in water is pumped though a spray cooking nozzle in which steam is mixed with the slurry and cooks the starch. The starch can be partially cooked or fully cooked. Upon atomization of the steam/slurry into the spray dryer, the spray cone is contacted with dry hydrocolloid (such as guar gum). The emerging spray hydrates the hydrocolloid, which can coat and agglomerate the starch particles. The elevated temperature of the spray changes the hydration of the dry hydrocolloid from typical agglomeration techniques. The resulting mixture is then dried with hot air and collected.

The starch product can be pasted and retain its all or most of its sustained release characteristics. The starch product can be added to a number of food products, such as bread, cakes, cookies, crackers, extruded snacks, soups, frozen desserts and beverages, for example. Consumption of the food products will result in slow release of dextrose in the small intestine with concomitant low insulin response.

Certain embodiments of the invention are described in the following examples.

### EXAMPLE 1

This product was made by agglomerating Waxy 1 7350 unmodified waxy cornstarch (available from Tate & Lyle, Decatur, Ill.) and Guar Gum 1100 (available from Tate & Lyle Custom Ingredients, Sycamore, Ill.) with a deionized water spray. The agglomeration was done using a Glatt ProCell 5 in top spray mode, with a GF insert.

Five hundred grams of the Waxy 1 7350 and twenty five grams of Guar Gum 1100 were placed into the fluid bed and agglomerated with 300 grams of water. The process was run with the following parameters:

| | | |
|---|---|---|
| Product Temp. | 48° | C. |
| Air Volume | 70 | m3/hr |
| Atomization Air | 1.5 | bar |
| Spray Rate | ~10 | g/min |

After 300 grams of the solution was sprayed, the pump and heater were shut off and the product was dried for 1 minute. The finished product was then discharged from the chamber and sieved through a 10 mesh screen to remove large particles.

### EXAMPLE 2

This product was made by extruding a dough made from purified water, Waxy 1 7350 unmodified waxy cornstarch and Guar Gum 1100. Four thousand eight hundred grams of the Waxy 1 7350 and two hundred and fifty two grams of Guar Gum 1100 were placed into a vertical granulator and agitated in the presence of 3000 grams of purified water spray. The resultant dough was then transferred to a basket extruder where it was pushed through 0.7 mm dies at 25 rpm. The resulting extruded material was then placed in a spheronizer for 3 minutes at 600 rpm. The product was then dried for ˜15 minutes in a fluid bed to a product temperature of approximately 40° C. The finished product was then discharged and milled prior to placement in product containers.

### EXAMPLE 3

### In Vitro Method for Sustained Release Carbohydrates

For an in vitro assay, enzymes and conditions that mimic the human digestive enzymes should ideally be used. The main enzyme active in human starch digestion is pancreatic α-amylase. The hydrolysis products of α-amylase are converted into glucose by the action of human brush border enzymes. The enzymes used in the in vitro assay are able to mimic the in vivo starch digestion well. Porcine pancreatic α-amylase has been shown to have similar action pattern on starch to human pancreatic α-amylase and amyloglucosidase is capable of hydrolyzing the α-amylase digestion products to glucose similar to the brush border enzymes in vivo. Glucose is measured as the product of this in vitro digestion and used to calculate digestibility of the test samples.

The new in vitro digestion method is based on the method of Englyst et al. (Englyst, H. N., S. M. Kingman and J. H. Cummings. 1992. Classification and measurement of nutritionally important starch fractions. Eur. J. Clin. Nutr. 46: S33-S50.). In this method starch samples are digested with pancreatin and amyloglucosidase at 37° C. for 2 hrs and the amount of non-digested material is defined as resistant starch. We found that the enzyme dosages used in this method are much too high. In order to correlate the in vitro data to in vivo data, the levels of pancreatin (pancrease, EC No 232-468-9, SIGMA (P7545), 6× USP specifications) and amyloglucosidase (AMG® 300L, Novozymes) were reduced up to 400 fold. Enzyme levels and digestion conditions were developed to correlate in vitro digestibility to in vivo blood glucose levels. The developed in vitro assay can be used to pre-screen potential prototype and determine chance of success in subsequent human clinical trials.

Detailed Procedure:

Add 0.5 g Pancreatin (pancrease, EC No 232-468-9, SIGMA (P7545), 6× USP specifications) to 60 mL de-ionized water and stir for 10 minutes.

Centrifuge at 4500 rpm for 10 minutes.

Combine 1 mL AMG (AMG® 300L, Novozymes) and 4 mL pancreatin supernatant and 95 mL water.

0.8 g (dry basis) sample

Add 20 mL of 0.M sodium acetate buffer (0.1M, pH 5.2, 0.016M CaCl₂) and vortex.

Equilibrate at 37° C. for 10 min with shaking.

1. After samples are equilibrated to 37° C. for 10 min, remove from the waterbath and add 5 glassballs (5 mm diameter) and 5 mL enzyme solution.

2. Place all samples into 37° C. shaker bath horizontally and shake at 160 rpm.

3. At different times during the digestion remove 100 μL sample from the tubes and add to 2 mL ethanol; vortex

4. Measure glucose using GODOP Kit supplied by Megazyme

% Digested=Glucose [g/sample]/TG [g/sample]

TG=total glucose potentially available from the sample (e.g. total starch wt*0.9 for starch samples)

Initial rate rinitial=[A15 min]/15 min units for r initial=[min−1]

Rate constant k: first order reaction

rate=−dt[A]/dt=k[A]

k=rate/[A] units fork are in [1/hr]

Where [A] is amount of sample digested (measured as glucose released)

This in vitro assay can be used to pre-screen potential sustained release carbohydrates and determine chance of success in subsequent human clinical trials. For three classes of carbohydrate ingredients we have found that:

Rapidly digestible: initial digestion rate (at 15 min)>1;

rate constant (k)>0.5

Slowly digestible/sustained release: initial digestion rate<1 and continued digestion over a 3 hour period;

rate constant (k)=0.1-0.4

Fiber: initial digestion rate<1 and no continued digestion after 30 min;
rate constant (k)<0.1

### EXAMPLE 4

### Processing Stability—Low Moisture Model System

An experimental design was set up to test different times and temperatures of processing in order to predict the processing stability of the prototype in different food applications at low moisture contents (e.g., 40% by weight moisture or less).

Responses measured were % digestible and initial digestion rate. % digestible was measured using the in vitro digestion method developed previously.

Using the same in vitro digestion method, the initial digestion rate (% digested/min) was calculated as: initial rate=% digested at 15 min/15.

The DOE (design of experiment) was setup using the Response Surface-Central Composite design provided by Design Expert 7 software. This type of experimental design utilizes extreme points as well as several center points, which allows for better statistical power and 3D graphical presentation of results. The selection of two blocks in the design setup accounts for possible day-to-day variation in sample preparation and data analysis methods. The limits for conditions to be tested were set at 5 and 45 min and 100° C. and 225° C. respectively for time and temperature treatments. This baking protocol resulted in products with moisture content ranging from about 40% (lower temp, shorter time) down to about 10% (higher temps, longer times)

A strong interaction between treatment temperature and time was found, especially at the 200° C. treatment temperature. The statistical model developed was significant for all response factors analyzed.

Response - Digestibility

| | | | |
|---|---|---|---|
| Std. Dev. | 7.32 | R-Squared | 0.8768 |
| Mean | 53.50 | Adj R-Squared | 0.8357 |
| C.V. % | 13.69 | Pred R-Squared | 0.7131 |
| PRESS | 1124.00 | Adeq Precision | 12.642 |

Digestibility = +37.33784 − 0.61753 * time − 0.022005 * Temperature + 8.60000E−003 * time * Temperature

Response - Digestion Rate:

| | | | |
|---|---|---|---|
| Std. Dev. | 0.17 | R-Squared | 0.9515 |
| Mean | 0.99 | Adj R-Squared | 0.9354 |
| C.V. % | 17.68 | Pred R-Squared | 0.9059 |
| PRESS | 0.53 | Adeq Precision | 21.419 |

Rate 15 min = +0.093339 − 0.019854 * time + 9.40925E−004 * Temperature + 3.02000E−004 * time * Temperature

TABLE 1
Design and results for low moisture model system

| | Factor 1 | Factor 2 | Response 1 | Response 2 |
|---|---|---|---|---|
| | A: time | B: T | Digestibility | Rate 15 min |
| Run | [min] | [deg C.] | [% digested] | [%/min] |
| 1 | 45 | 225.0 | 86 | 2.4 |
| 2 | 25 | 162.5 | 53 | 1.1 |
| 3 | 5 | 100.0 | 37 | 0.1 |
| 4 | 25 | 162.5 | 47 | 0.9 |
| 5 | 45 | 100.0 | 41 | 0.6 |
| 6 | 5 | 225.0 | 39 | 0.4 |
| 7 | 25 | 162.5 | 48 | 1.0 |
| 8 | 25 | 162.5 | 60 | 0.9 |
| 9 | 1 | 162.5 | 30 | 0.2 |
| 10 | 53 | 162.5 | 80 | 1.7 |
| 11 | 25 | 162.5 | 71 | 1.3 |
| 12 | 25 | 74.1 | 31 | 0.2 |
| 13 | 25 | 162.5 | 60 | 1.3 |
| 14 | 25 | 250.9 | 66 | 1.7 |

### EXAMPLE 5

### Processing Stability—High Moisture Model System

An experimental design was set up to test different times and temperatures of processing in order to predict the processing stability of the prototype in different food applications at high moisture contents (e.g., 80% by weight moisture or more).

Responses measured were % digestible and initial digestion rate. % digestible was measured using the in vitro digestion method developed previously.

Using the same in vitro digestion method, the initial digestion rate (% digested/min) was calculated as: initial rate=% digested at 15 min/15

The DOE was setup using the Response Surface-Central Composite design provided by Design Expert 7 software. This type of experimental design utilizes extreme points as well as several center points, which allows for better statistical power and 3D graphical presentation of results. The selection of two blocks in the design setup accounts for possible day-to-day variation in sample preparation and data analysis methods. The heating protocol used in this study resulted in products with about 93% moisture content.

A strong interaction between treatment temperature and time was found, especially at the 67.5° C. treatment temperature. The statistical model developed was significant for all response factors analyzed.

Response - Digestibility

| | | | |
|---|---|---|---|
| Std. Dev. | 4.29 | R-Squared | 0.8025 |
| Mean | 52.57 | Adj R-Squared | 0.6615 |
| C.V. % | 8.16 | Pred R-Squared | −0.5917 |
| PRESS | 1039.12 | Adeq Precision | 7.429 |

Digestibility = +57.24663 + 0.50921 * time − 0.82896 * Temperature + 4.00000E−003 * time * Temperature − 0.012499 * time² + 9.08851E−003 * Temperature²

Response - Digestion Rate:

| | | | |
|---|---|---|---|
| Std. Dev. | 0.38 | R-Squared | 0.7773 |
| Mean | 1.27 | Adj R-Squared | 0.7031 |
| C.V. % | 30.04 | Pred R-Squared | 0.1762 |
| PRESS | 4.86 | Adeq Precision | 9.081 |

Rate 15 min = −3.26794 + 0.023162 * time + 0.063627 * Temperature − 2.00000E−004 * time * Temperature

TABLE 2
Design and results for high moisture model system

| | Factor 1 | Factor 2 | Response 1 | Response 2 |
|---|---|---|---|---|
| | A: time | B: T | Digestibility | Rate 15 min |
| Run | [min] | [deg C.] | [%] | [%/min] |
| 1 | 25 | 67.5 | 56 | 1.3 |
| 2 | 5 | 80.0 | 57 | 2.3 |
| 3 | 25 | 67.5 | 59 | 1.3 |
| 4 | 45 | 55.0 | 43 | 0.4 |
| 5 | 25 | 67.5 | 59 | 1.3 |
| 6 | 45 | 80.0 | 60 | 2.1 |
| 7 | 5 | 55.0 | 44 | 0.4 |
| 8 | 25 | 49.8 | 50 | 0.5 |
| 9 | 25 | 67.5 | 54 | 1.3 |
| 10 | 53 | 67.5 | 52 | 1.6 |
| 11 | 25 | 85.2 | 64 | 2.1 |
| 12 | 25 | 67.5 | 51 | 1.1 |
| 13 | 1 | 67.5 | 39 | 0.3 |
| 14 | 25 | 67.5 | 48 | 1.8 |

In the following examples, certain commercially available materials were used, including the following:

X-PAND'R® pregelatinized waxy maize starch, PROMITOR™ resistant starch, PROMITOR™ soluble corn fiber 70, MIRA-THIK® 603 starch, Sweetener REBALANCE™ X60 and REBALANCE™ M60 (both containing SPLENDA® sucralose and maltodextrin), Amygluten 160 vital wheat gluten, STA SLIM® 150 pregelatinized modified tapioca starch, STAR DRI® 1015A maltodextrin, all of which are available from Tate & Lyle;

Pan-O-Lite phosphate salts, available from ICL Performance Products; and

Protanal BK 0854 alginate, available from FMC BioPolymer.

### EXAMPLE 6

### Crackers

| | Test |
|---|---|
| Ingredients | % |
| Sustained Release Carbohydrate | 34.88 |
| X-PAND'R ® | 6.19 |
| PROMITOR ™ Resistant Starch | 3.38 |
| PROMITOR ™ Soluble Corn Fiber 70 | 4.00 |
| Amygluten 160 | 6.03 |
| Vream All-Purpose shortening | 5.59 |
| KRYSTAR ® 300 crystalline fructose | 0.32 |
| Monocalcium phosphate | 0.40 |
| Sodium bicarbonate | 0.35 |
| Salt | 0.30 |
| Canadian Harvest Oat Fiber 500-48 | 5.03 |
| Water | 33.53 |
| Total | 100 |

In all of these examples, the sustained release carbohydrate was produced by the following method: 950 g of waxy maize starch is dry blended with 50 g Guar Gum. This blend is rewet agglomerated in the Glatt Pro-Cell 5 with GF insert for 30 minutes with an average spray rate of 28 g water/min at 1.5 bar nozzle pressure. The bed is fluidized with 70 m³/h of air, and held at 40° C.

Steps: Mix dry ingredients using a Hobart mixer on speed 1 for 1 minute. Add melted shortening and mix for 30 seconds. Add water (85-90° F.) and mix for additional 1.5 minutes. Form dough into ball. Sheet dough using Rondo sheeter to 0.9-1.1 mm thickness. Cut dough into pieces and dock. Bake on perforated pan at 375° F. for 7 minutes. For the test formula, the dough was laminated 3 times during sheeting to maintain a cohesive dough.

In the following examples, the Sustained Release Carbohydrate used had the same composition and was prepared with the same procedure as described in Example 6.

### EXAMPLE 7

### Soft-Type Cookies

| | Test |
|---|---|
| Ingredients | % |
| Part A | |
| PROMITOR ™ Soluble Corn Fiber 70 | 23.30 |
| Vream All-purpose shortening | 13.37 |
| Sorbitol | 1.07 |
| MIRA-THIK ® 603 | 0.97 |
| Salt | 0.53 |
| Cinnamon | 0.32 |
| Sweetener REBALANCE ™ X60 | 0.32 |
| Cinnamon flavor #528126-Givaudan | 0.27 |
| Part B | |
| Water | 9.89 |
| Glycerine | 2.41 |
| Dry whole egg | 1.28 |
| Vanilla flavor 528186-Givaudan | 0.27 |
| Part C | |
| Sustained Release Carbohydrate | 23.36 |
| Amygluten 160 | 2.31 |
| Quick rolled oats | 12.83 |
| Baking soda | 0.64 |
| Pan-O-Lite | 0.43 |
| Part D | |
| Chopped walnuts | 6.42 |
| Total | 100 |

Steps: Mix Part A ingredients using Hobart on speed 1 for 1 minute, scrape bowl, and mix on speed 2 for 2 minutes. Add Part B ingredients and mix on speed 1 for 1 minute and speed 2 for 2 minutes. Add Part C ingredients and mix on speed 1 for 2 minutes. Add the raisins and walnuts and mix on speed 1 for 15 seconds or until dough is uniform. Form the dough into 32 g balls and place on parchment lined baking sheet. Bake at 350° F. for 10 minutes.

### EXAMPLE 8

### Cereal Bars

| | Test |
|---|---|
| Ingredients | % |
| Sustained Release Carbohydrate | 25.60 |
| Water | 8.15 |
| Soy protein crisps (80% protein) | 23.40 |
| STA LITE III ® polydextrose | 31.18 |
| STA SLIM ® 150 | 2.50 |
| Sorbitol | 6.00 |
| Canola oil | 2.55 |
| Lecithin | 0.10 |
| Brown sugar flavor | 0.31 |
| Vanilla flavor | 0.13 |
| SPLENDA ® Sucralose, 25% solution | 0.08 |
| Total | 100 |

Steps: Heat the binder ingredients (all except sustained release and soy crisps) until the temperature reaches 140° F. and all ingredients are blended together. Add binder to sustained release and mix until homogenous. Add the crisps and mix. Place onto parchment paper and roll into bars 4″ long. Chill and cut into bars.

### EXAMPLE 9

### Cheese Filling for Sandwich Cracker

| | Test |
|---|---|
| Ingredients | % |
| Alcolec S Lecithin | 0.50 |
| Sustained Release Carbohydrate | 35.10 |
| Shortening | 34.00 |
| Cheddar Filling A | 13.00 |
| Nacho Cheese Flavor | 12.75 |
| Cheese Flavor, Exceed 409 | 3.00 |
| Salt | 1.30 |
| Lactic Acid Powder | 0.20 |
| Citric Acid, Anhydrous | 0.15 |
| Total | 100 |

Steps: Mix canola oil/shortening and lecithin in a mixing bowl with paddle attachment on speed 1 for 1 minute. Add cheese flavors, cheddar filling, salt, and acids and mix for 1 minute or until homogenous. Add remaining ingredients and continue to mix for a total of 3 minutes or until smooth and homogenous.

### EXAMPLE 10

### Instant Pudding

| | Test |
|---|---|
| Ingredients | % |
| Sustained Release Carbohydrate | 69.25 |
| Cocoa D-11-S | 16.00 |
| STAR DRI ® 1015A maltodextrin | 0.00 |
| Tetrasodium Pyrophosphate | 4.50 |
| Disodium Phosphate | 4.50 |
| Bealite EV Emulsifier | 3.20 |
| Lambda Carrageenan | 0.10 |
| Vanilla Flavor #464174 | 0.70 |
| Salt | 1.25 |
| SPLENDA ® Sucralose | 0.36 |
| Chocolate Shade | 0.14 |
| Total | 100 |

Steps: Blend dry ingredients together. Add 2 cups of cold whole milk to a mixing bowl and start beaters on slow-medium speed. Add the dry mix (32 g—control, 100 g—SRC) slowly while beating. Scrape sides with spatula and continue mixing until smooth. Pour into cups and chill for at least 10 minutes.

### EXAMPLE 11

### Mousse

| | Test |
|---|---|
| Ingredients | % |
| Part A | |
| Sustained Release Carbohydrate | 28.75 |
| Emulsifier, myvatex Texture Lite | 1.25 |
| Emulsifier, Durfax 60 | 0.14 |
| Part B | |
| Non-fat dry milk, low heat | 4.14 |
| Cocoa, D-11-A | 3.33 |
| Dried egg whites, type P-110 | 1.65 |
| Cocoa, N-11-N | 1.64 |
| Baking Soda | 0.3 |
| Artificial vanilla powder 831148 | 0.09 |
| SPLENDA ® Sucralose | 0.04 |
| Part C | |
| Water | 56.67 |
| Total | 100 |

Steps: With the exception of Durfax 60 emulsifier, place Part A ingredients in mixing bowl and dry blend. Melt the Durfax 60 emulsifier and coat onto the dry blended ingredients while mixing on speed 1. Add Part B ingredients and mix until uniform and set aside. Place hot (120-130° F.) water into a bowl. Using a hand held mixer, add the dry ingredients and mix for 1 minute on speed 1. Mix for 30 seconds on speed 3, scrape bowl, and continue mixing until desired consistency is met. Refrigerate before serving.

### EXAMPLE 12

### Éclair

| Shell | Test |
|---|---|
| Ingredients | % |
| Water | 35.20 |
| Salt | 0.20 |
| Butter | 16.69 |
| Pastry flour | 0.00 |
| Sustained Release Carbohydrate | 16.05 |
| Amygluten 160 | 1.59 |
| Eggs | 30.27 |
| Total | 100 |

Steps: Boil water, butter, and salt in small heavy pan over medium heat. As soon as it reaches a rapid boil, turn heat to low and add the flour/sustained release carbohydrate all at once while stirring. Continue cooking until the paste starts to pull away from the sides of the pan and forms a ball. Transfer the paste to a mixing bowl and let the paste cool to 115° F. before adding eggs. Add eggs one at a time, allowing the dough to smooth out before adding the next portion. The bottom and sides of bowl should be scraped down at least once during mixing. Pipe the éclairs onto parchment lined pan. They should be roughly 3½ inches long and weigh 35 g. Bake at 400° F. for 40-45 minutes. Shells are removed when they are golden brown and have a light hollow sound when tapped gently with a spoon. Allow the shells to cool completely before adding the filling.

| Filling | Test |
|---|---|
| Ingredients | % |
| Sustained Release Carbohydrate | 26.9 |
| Nonfat dry milk —low heat | 7.8 |
| Protanal BK 0854 | 0.6 |
| Baker's Egg Shade | 0.002 |
| N&A Vanilla Dairy | 0.22 |
| SPLENDA ® Sucralose | 0.028 |
| Water | 64.45 |
| Total | 100 |

Steps: Place cold water in mixing bowl with whisk attachment. Add dry blend of ingredients while mixing on low speed for 30-50 seconds. Mix on high speed for 2-3 minutes and fill shell.

### EXAMPLE 13

### Muffins

| | Test |
|---|---|
| Ingredients | % |
| Part A | |
| Vegetable shortening | 10.50 |
| Sorbitol | 12.38 |
| Sweetener REBALANCE ™ M60 | 0.23 |
| STA-LITE ® III polydextrose | 10.00 |
| Salt | 0.30 |
| Part B | |
| Sustained Release Carbohydrate | 36.42 |
| Water | 25.31 |
| Dry whole egg | 3.00 |
| Baking soda | 0.50 |
| Leavening agent, Pan-O-Lite | 0.50 |
| Sodium Propionate | 0.20 |
| Emulsifier, Starplex 90 | 0.18 |
| (Distilled monoglycerides) | |
| Emulsifier, Emplex (SSL) | 0.08 |
| Emulsifier, Lecithin | 0.15 |
| Orange flavoring | 0.25 |
| Total | 100 |

Steps: Place Part A ingredients in Hobart mixing bowl and mix on speed 1 for 1 minute. Then speed 2 for 1 minute. Add Part B ingredients except water and cranberries. Mix on speed 1 for 1 minute, then speed 2 for 1 minute. Add cranberries and mix on speed 1 for 15 seconds. Weigh 15 grams of dough into mini muffin cups. Bake at 400° F. for 12 minutes 15 seconds.

### EXAMPLE 14

### Peanut Butter Filling

| | Test |
|---|---|
| Ingredients | % |
| Peanut Butter with no additives | 67 |
| Sustained Release Carbohydrate | 33 |
| Total | 100 |

Steps: Place peanut butter in a mixing bowl with paddle attachment and mix on speed 1 for 1 minute. Slowly add sustained release carbohydrate and mix until homogeneous.

The preceding description of specific embodiments of the invention is not intended to be a list of every possible embodiment of the invention. Persons skilled in the art will recognize that other embodiments would be within the scope of the following claims.

What is claimed is:

1. A process for producing a sustained release starch product, comprising:
combining and mixing starch, hydrocolloid, and water to form a starch material; and
drying the starch material to form a starch product;
wherein when the starch product is ingested by a human, a blood glucose level above baseline is maintained for at least 120 minutes after ingestion.

2. The process of claim 1, wherein the starch material comprises about 80-99.9% by weight starch and about 0.1-20% by weight hydrocolloid on a dry solids basis.

3. The process of claim 1, wherein the starch material comprises about 0.1-50% by weight water.

4. The process of claim 1, wherein the starch, hydrocolloid, and water are combined by first combining the starch and hydrocolloid and then adding water.

5. The process of claim 1, wherein the starch, hydrocolloid, and water are combined by adding hydrocolloid to an aqueous starch slurry.

6. The process of claim 1, wherein the combining and mixing are done simultaneously.

7. The process of claim 1, wherein the combining and mixing are done sequentially.

8. The process of claim 1, wherein the mixing is done by at least one of agglomeration, extrusion, or roll compaction.

9. The process of claim 1, wherein the starch is native maize starch or waxy maize starch.

10. The process of claim 1, wherein the hydrocolloid is xanthan gum, guar gum, locust bean gum, pullulan, or a combination of two or more thereof.

11. The process of claim 1, wherein the starch, hydrocolloid, and water are combined and mixed by:
forming an aqueous starch slurry;
pumping the slurry through a spray cooking nozzle, where steam is formed and cooks the starch at least partially, resulting in a spray of cooked starch particulates from the nozzle; and
contacting the spray of cooked starch particulates with hydrocolloid particulates.

12. The process of claim 11, wherein the starch is waxy starch.

13. A sustained release starch product produced by the process of claim 1.

14. The sustained release starch product of claim 13, wherein the product has an initial digestion rate<1, a rate constant (k) in the range of 0.1 to 0.4, and shows continued digestion over a 3 hour period.

15. The sustained release starch product of claim 13, wherein the product is produced by the process of claim 11.

16. A food product comprising the sustained release starch product of claim 1.

17. The food product of claim 16, wherein the sustained release starch product is the product of claim 11.
